(19) United States
(12) Patent Application Publication
(10) Pub. No.: US 2010/0159042 A1
(43) Pub. Date: Jun. 24, 2010

(54) CAPSICUM BASED MILDEW KILLING SOLUTION AND METHOD OF USE

(76) Inventor: Robert E. Neumann, San Carlos, CA (US)

Correspondence Address: RAY K. SHAHANI, ESQ., ATTORNEY AT LAW, TWIN OAKS OFFICE PLAZA, 477 NORTH NINTH AVENUE, SUITE 112, SAN MATEO, CA, 94402-1858, US

(21) Appl. No.: 12/340,562

(22) Filed: Dec. 19, 2008

(51) Int. Cl. A01N 65/38; A01P 3/00

(52) U.S. Cl. 424/760

(57) ABSTRACT

A method for killing fungus and preventing destruction of agricultural crops and other vegetation by fungal infections consisting of contacting the crop with an aqueous formulation containing capsicum. The method comprises spraying the vegetation and with the aqueous formulation containing capsicum, to vegetation or other agricultural products to treat and prevent destruction by fungal infection.

### RELATED APPLICATIONS

This application is related to U.S. application Ser. No. 10/741,328 filed Dec. 19, 2007, Attorney Docket No. NEU-108 entitled CAPSICUM BASED SEED COATING AND METHOD OF USE, now abandoned, which is a Continuation-In-Part of U.S. application Ser. No. 10/158,593 filed May 30, 2002, Attorney Docket No. NEU-107 entitled CAPSICUM BASED SEED COATING AND METHOD OF USE, now abandoned, which is a non-provisional application of U.S. Provisional Application Ser. No. 60/294,374 filed May 30, 2001, Attorney Docket No. NEU-107-P entitled CAPSICUM BASED SEED COATING AND METHOD OF USE, and claims any and all benefits of priority of filing dates as it is entitled to. This application is also related to U.S. patent application Ser. No. 09/867,940 filed May 30, 2001, Attorney Docket No. NEU- 106 entitled CAPSICUM BASED DISINFECTANT AND STERILIZANT, now U.S. Pat. No. 6,632,839, and U.S. patent application Ser. No. 09/867,945 filed May 30, 2001, Attorney Docket No. NEU-105 entitled CAPSICUM BASED PESTICIDE AND METHOD OF USE, now U.S. Pat. No. 6,505,436, which both are Continuation-In-Part of U.S. patent Ser. No. 09/747,225 filed Dec. 22, 2000, Attorney Docket No. NEU-103 entitled CAPSICUM BASED PESTICIDE AND METHOD OF USE, now U.S. Pat. No. 6,523,298, which is a Continuation-In-Part of U.S. patent application Ser. No. 09/374,548 filed Aug. 12, 1999, Attorney Docket No. NEU- 102 entitled CAPSICUM BASED PESTICIDE AND METHOD OF USE, now abandoned, which is a Continuation of U.S. Pat. No. 5,937,572 issued Aug. 17, 1999, Attorney Docket No. NEU- 101 based on application Ser. No. 08/871,004 filed June 6, 1997, Attorney Docket No. NEU-101 entitled CAPSICUM BASED INSECTICIDE AND METHOD OF USE and claims any and all benefits of priority of filing dates as it is entitled to.

### FIELD OF THE INVENTION

The present invention relates generally to methods of prevention and treatment of mildew on vegetation or other agriculture products. More particularly, the present invention is a novel compound and method for inhibiting growth of and removing fungi that cause Downey or powdery mildew diseases on crops such as for agricultural purposes, using an aqueous solution comprising capsicum, a chemical non-toxic to humans and highly active against fungi and living insects.

### BACKGROUND OF THE INVENTION

Presently, much is known about capsicum. A current internet site located on the world wide web at http://neptune.netimages.com/%7Echile/science.html provides a great deal of background information. Peppers are members of the genus Capsicum, and the family Solanaceae, which include eggplant and tomatoes. The name Capsicum comes from the Greek kapto, which means “to bite”.

It is estimated that there are at least 26 species of peppers categorized at present, most of which are found in the wild. There are five species of domesticated peppers:(1) annuum, from “annual; this includes most of the common peppers found in markets including bell peppers, jalapeños and New Mexican; (2) baccatum, from “berry-like”; these are the aji peppers found commonly in South America; (3) chinense, meaning “from China”; this includes the famous habanero, Scotch Bonnets, etc.; (4) frutescens, meaning “brushy” and are the tabasco peppers; and (5) pubescens, from “hairy”; these are the South American rocoto peppers. References to annuum species often include the pod type. Due to easy inbreeding between annuum, chinense and frutescens, there are hundreds of different varieties found throughout the world. All peppers originated in the New World. The origin seems to be in the area of Bolivia and Paraguay in South America. Wild peppers were spread by birds, who are apparently unaffected by the heat of the fruit.

Many varieties of the Capsicum species are not hot, or pungent. Most paprikas grown in Europe and bell peppers grown in the US have little or no pungency. These varieties are used fresh, or often used to color other foods. The wilder varieties, on the other hand, range from mildly to extremely pungent. This is entirely due to the substance capsaicin, or, actually, a group of similar substances called capsaicinoids. Pure capsaicin, or 8-methyl-n-vanillyl-6-nonenamide, is a whitish powder which is soluble in alcohol but insoluble in cold water, which is why drinking water to help alleviate the burning won't work. The capsaicinoids are unique compared to other “spicy” substances such as mustard oil (zingerone and allyl isothiocyanate), black pepper (piperine) and ginger (gingerol) in that capsaicin causes a long-lasting selective desensitization to the irritant pain by repeated doses of a low concentration or a single high concentration dose.

Powdery mildew (uncinula necator) is a fungal disease that affects a wide range of plants. Powdery mildew diseases are caused by many different species of fungi in the order Erysiphales. It is one of the easier diseases to spot, as its symptoms are quite distinctive. Infected plants display white powder-like spots on the leaves and stems. The lower leaves are the most affected, but the mildew can appear on any part of the plant that shows above the ground. As the disease progresses, the spots get larger and thicker as massive numbers of spores form, and the mildew spreads up and down the length of the plant.

Downy mildew (plasmopara viticola) refers to any of several types of oomycete microbes that are obligate parasites of plants. Downy mildews exclusively belong to Peronosporaceae. In commercial agriculture, they are a particular problem for growers of crucifers, grapes and vine-type vegetables.

Numerous applications of capsicum for medicinal or therapeutic purposes, such as in cough drop formulations, analgesics, thermo-slimming cosmetic compositions, ache and pain compounds and arthritis compositions are found in U.S. Pat. Nos. 4,980,169, 4,931,277, 4,702,916, 4,795,638, 4,592,912 and 4,271,154. These applications are unrelated to the present invention.

Numerous applications include the use of capsicum to discourage growth of living organisms. U.S. Pat. No. 5,226,380 to Fischer teaches a covering material for underwater objects such as boat hulls or water intake pipes. The covering includes a waterproof coating such as adhesive or paint containing capsicum derivatives such as cayenne pepper or oleoresin capsicum, with the coating applied to the outer surface of the object to be protected, to repel marine organisms which might otherwise attach themselves to the object.

With regard to the prior art teaching the use of capsicum as an adjunct ingredient to a fungicidal composition, all of these compositions include the use of other, non-capsicum based chemicals. The use of capsicum therein is as an adjunct, not as a replacement. The use of a solution of capsicum alone in water is neither taught nor suggested in any of the relevant prior art available.

The use of capsicum in an aqueous solution for preventing and treating plants with powdery mildew diseases is unknown. Numerous other uses for chile peppers have been described. U.S. Pat. No. 5,217,708 to Pinkney teaches an aerosol lachrymator formulation having all natural pepper extracts as the active ingredients. The lachrymator formulations are useful in self-defense devices. The formulations are non-toxic and have a broader spectrum of activity than man-made lachrymators. These aerosol formulations rely on a carbon dioxide propellant.

In the generally well known and accepted prior art for the treatment and prevention of fungal infestations, little is known regarding the availability of cheap, efficacious and non-toxic to humans formulations or methods. The majority of fungicides that can be bought retail are sold in a liquid form. The most common active ingredient is sulfur, running at 0.08% for the weaker concentrates, and has high as 0.5% for the more potent fungicides. Triademefon and propiconazole are examples of fungicides that utilize sulfur as the key active ingredient. Sulfur is harmful to crops when it seeps into the soil. In powdered form, the concentration is usually around 90% which is very toxic. Capsicum is a cheaper and safer solution to sulfur.

One of the drawbacks of using sulphur solutions is that they can create splashes, leaks, vapors, steam if heated, fogs or sprays. Handling such materials can be dangerous, difficult, and may require certain equipment including special containers, special pouring and mixing techniques or equipment, specialized protective clothing, for workers, etc. It would be desirable to provide a liquid fungicidal composition which comprises capsicum as the active killing agent along without the drawbacks described above.

One method used in the agricultural industry to prevent fungal infections to crops is crop rotation. Crop rotation with non-host plants is a method to keep fungal infections to a minimum, and reducing splash from contaminated soil also helps control spores. However, this method requires extra efforts to rotate the crop and only keeps the infections to a minimum which helps to prevent but not treat crops for fungus. Therefore, it is desirable to develop an alternative for the use of crop rotation to maximize efficiency of time and work spent.

U.S. Pat. No. 7,332,518 issued Feb. 19, 2008, entitled “CARBOXAMIDES AS FUNGICIDES IN AGRICULTURE” to Walter, et al. and U.S. Pat. No. 7,338,967 issued Mar. 4, 2008, entitled “SUBSTITUTED ISOXAZOLES AS FUNGICIDES” to Lee, et al., both teach the use of chemcial solutions or salt for use as fungicides. However, both do not reference the use of Capsicum as an active ingredient for their compounds.

U.S. Pat. No. 6,310,091 issued Oct. 30, 2001, entitled “FUNGICIDAL SAPONIN, CAY-1, AND ISOLATION THEREOF FROM CAPSIUM SPECIES FRUIT” to De Lucca, II et al. teaches a antifungal compound, “CAY-1” which is isolated from the dried fruit of Capsicum frutescens (cayenne pepper). However, the patent teaches a very specific sterol glycoside (a saponin) with a molecular mass of 1243.35 Da which is very different from the present invention. Also, it does not mention capsicum as an active ingredient in the antifungal compound.

### ADVANTAGES AND SUMMARY OF THE INVENTION

Therefore, it is an advantage and object of the present invention to provide a safe and economical method and composition formulation for preventing fungal and/or mildew infection to crops. The composition can be applied to fruiting bodies and plants at the early stage of bud growth. New buds can be treated as they emerge, and fruit can be treated at the size of small peas. Treatment can be repeated if necessary.

It is a further advantage and object of the present invention to provide preventive measures against both powdery mildew and Downey mildew at the same time.

It is a further advantage and object of the present invention to provide such method and composition which is environmentally safe.

It is a further advantage and object of the present invention to provide such method and composition which is environmentally safe.

It is a further advantage and object of the present invention that the treated crops such as grapes retain their original taste.

It is yet a further advantage and object of the present invention to provide a method and formulation of preventing damage to all types of vegetation from being damaged by infections caused by fungus.

It is yet a further advantage and object that the present invention is also a non-toxic, safe, effective and environmental friendly pesticide and insecticide.

It is yet an advantage and object of the present invention to provide long-lasting protection against powdery and Downey mildew for crops.

In summary, the present invention is a method for treating vegetation and other similar agricultural products to render them free and safe from damage by powdery mildew and Downey mildew using an aqueous solution that has a predetermined amount of capsicum.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is the chemical structure of capsaicin.

FIG. 2 is a plot graph showing biodegradation of different types of oils in shake flask tests.

### DETAILED DESCRIPTION OF THE PREFERRED EMBODIMENT

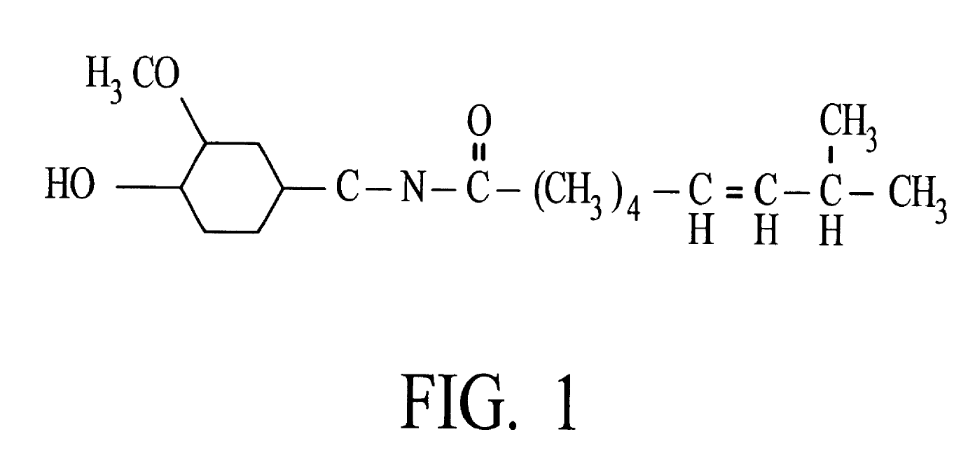

FIG. 1 is the chemical structure of capsicum or capsaicin 100. Capsaicin, also known as N-vanillyl-8-methyl-6-(E)-noneamide, is the most pungent of the group of compounds called capsaicinoids isolated from peppers. It is sparingly soluble in water, but very soluble in fats, oils and alcohol. The second most common capsaicinoid is Dihydrocapsaicin. Capsaicin and Dihydrocapsaicin together make up 80-90% of the capsaicinoids found in the fruit. In C. annuum the total capsaicinoid content ranges from 0.1 to 1.0%, and the capsaicin:dihydrocapsaicin ratio is about 1:1. In C. frutescens(Tabasco peppers) the total content ranges from 0.4-1.0% with the ratio around 2:1.

The minor capsaicinoids include Nordihydrocapsaicin [Dihydrocapsaicin with (CH2)5 instead of (CH2)6], Homocapsaicin [Capsaicin with (CH2)5 instead of (CH2)4], and Homodihydrocapsaicin [Dihydrocapsaicin with (CH2)7 instead of (CH2)6]. The pungencies of these five pure compounds in Scoville Units (SU) are as follows:

| Compound | Pungency × 100,000 SU |
|---|---|
| Capsaicin | 160 |
| Dihydrocapsaicin | 160 |
| Nordihydrocapsaicin | 91 |
| Homocapsaicin | 86 |
| Homodihydrocapsaicin. | 86 |

Govindarajan, V S and Sathyanarayana, M N; Capsicum—Production, Technology, Chemistry and Quality. Part V. Impact on Physiology, Nutrition and Metabolism; Structure, Pungency, Pain and Desensitization Sequences, Crit. Rev. Food Sci. Nutr. 29, 435. 1991 There are also homologs and analogs, such as with straight alkyl chains, that exist in nature.

Quantization of capsicum amount in solutions is an important tool in manufacture. Following is a high performance liquid chromatography (HPLC) method for capsaicin determination: 25 g ground red pepper extracted in 200 mL 95% ethanol at 65-75 C for 5 hours, allow to settle, decant, and cool to 20 C. 50 microliters injected from a 100 microliter Hamilton LC syringe via a Waters U6K injector into a Waters HPLC system with a 10 micron micro-Bondapak C18 column and a Bondapak C18/Corasil guard column and a UV detector set at 280 nm. HPLC operated isocratically with a Waters 660 solvent programmer using a mobile phase of 40:60 v/v acetonitrile:water (1% acetic acid) at 1.5 mL per minute. Quantization done using commercially available N-vanillyl-n-nonamide as an external standard. Hoffman, Patrick G.; Lego, Mary C.; and Galetto, William G. “Separation and Quantization of Red Pepper Major Heat Principles by Reverse-Phase High-Pressure Liquid Chromatography” J. Agric. Food Chem. 1983, vol. 31 pp 1326-1330.

In an embodiment, the concentration of liquid capsaicin in the aqueous solution is about 1 to 250 or more or less. In another embodiment, the concentration of liquid capsaicin in the aqueous solution is about 1 to 50 to about 1 to 500, or more or less.

Experimentally, it has been found that capsicum containing aqueous solutions are effective for exterminating drywood, subterranean and dampwood termites, wood boring beetles, fungi of various types including those cause powdery mildew and Downey mildew, mosquitoes, flies, earthworms and spiders. Using a hot, pungent variety of a typical pepper such as C. annuum with an average of about 0.5% capsaicin content, a solution containing as little as 10 grams of ground pepper in about 454 mL water will contain about 0.01% capsaicin, sufficient for most applications disclosed herein. Therefore, optimally an aqueous solution will contain between about 0.00001% and about 1.0% by weight capsaicin or capsicum.

The solution can be formed using ground peppers mixed directly into water. The peppers may be dried or fresh, chopped or ground or powdered. To increase solubility of certain preparations of chilli peppers, the temperature of the water can be raised to room temperature or above. Electric or manual mixers can be employed, and it will be understood that a certain, predetermined time constant related to the solubility of the pepper material in the aqueous solution will be a factor to consider in preparing the solution.

It will be understood, therefore, that alternative methods of treating vegetation include applying the preventive solution, in either a vapor, spray, mist or liquid form. Applying the solution should be typically at a rate of about ½ the usual spray application from a standard tractor rig. The solution is to be administered from the sides.

It will be understood, additionally, that the term capsicum as used herein shall serve to include any material containing, but not limited to, capsicum itself, any chemically synthesized or natural extract of any plant of the genus Capsicum, any material containing capsaicin, any of the capsinoids or capsaicinoids, homologs, analogs, derivatives or similar compounds or formulations.

### Solvent/Carrier

As described above, the principle solvent for the formulations of the present invention is water. Additional chemicals in the present formulation include surfactants, sticking agents, preservatives or biocidal agents, coloring dyes or agents, fragrance, etc.

In one embodiment, the formulation of the present invention contains mineral oil. In one embodiment, the preventive solution contains a sticking agent. In one embodiment, the method for preventing fungal growth on vegetation with an aqueous formulation containing capsicum and mineral oil whereby the aqueous formulation is a preventive solution. In an embodiment, the concentration of mineral oil in the aqueous solution is about 1 to 250 or more or less. In another embodiment, the concentration of mineral oil in the aqueous solution is about 1 to 50 to about 1 to 500, or more or less.

As described above, the addition of an inert carrier oil assists in handling of the liquid preventive formulations containing capsicum. Mineral oil has been found to be a preferred additive to the present invention. Use of mineral oil in the formulation enhances dispersion, reduces fogging or misting of a potentially irritating or noxious odor. Mineral oil is non-toxic to humans, and is safe to use in households and other animal and people environments. The inert carrier oil added to the killing solution can be a combination of one or more inert carrier oils selected from the group consisting of mineral oil, organic oils, animal and vegetable oils, castor oil, hydrocarbon oils, and paraffinic oils.

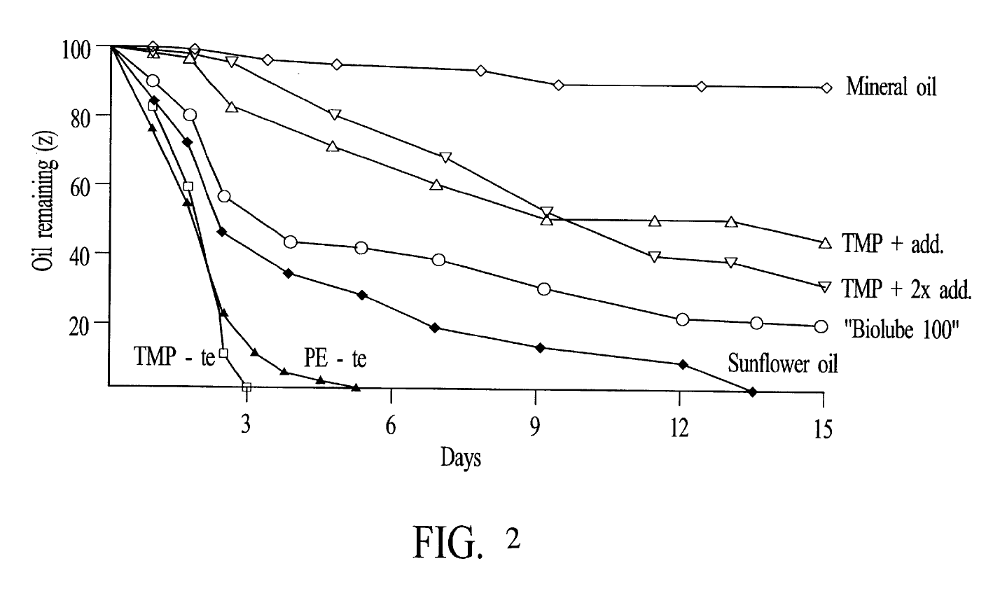

FIG. 2 is a plot graph showing biodegradation of different types of oils in shake flask tests. The inoculum used is regular lake water. The oils were added at 0.01% (V/V) to M9 mineral salts medium (50 mL) in 250-mL-volume conical flasks and inoculated with 1 mL of lake water bacteria collected on a bacterial filter and resuspended to 105 cfu/mL. Flasks were incubated at 25° C. and shaken at 100 rev/min. Control flasks were poisoned with HgCl₂ at zero time and showed that oil disappearance by abiotic agencies was less than 7% in all cases. The oils used were: (1) mineral oil; (2) a TMP-triester; (3) a pentaerythritol tetraester; (4) sunflower seed oil; (5) “Biolube 100”, a commercial fully-formulated 2-stroke oil containing a TMP-ester base oil; (6) TMP-triester with a commercial additive package added at a normal level; and (7) the same oil containing twice the normal additive level.

It will be understood that the low rates of biodegradation of mineral oils contribute to the benefit of the present invention. Mineral oils, compared to other oils, have the added benefit of being resistant to biodegradation. The residue containing the active ingredient capsicum, or other form of capsaicin, is effective to prevent fugual growth in the form of powdery mildew and Downey mildew for longer than would be possible using other forms of carrier oils.

The following table is a short list of specification for a few different types of mineral oils available:

Inert Carrier Oil Specifications
Spray Spec's Oil-Base

| Viscosity @ 100° F., Sus | 60-65 N | 70 N | 70-100 N | 150 N |
|---|---|---|---|---|
| Mass Boiling, | 35 max | 10 max | 10 max | 10 max |
| % < 340° C.,¹ | | | | |
| Mass Boiling, | 10 max | 35 max | 70 max | 70 max |
| % > 393°,² | | | | |
| Paraffinic, %,³ | 60 min | 60 min | 60 min | 60 min |
| Aromatic, % | 3 max | 3 max | 4 max | 5 max |
| Acidity, mg KOH after | 0.3 max | 0.3 max | 0.1 max | 1.0 max |
| exposure to UV,⁴ | | | | |

¹This temp equivalent to C₂₀ n-paraffin and is the lower limit for pesticidal activity.
²Equivalent to a C₂₄ n-paraffin. The fraction boiling > C₂₄ can be phytotoxic due to prolonged ex-cuticular perseverance with subsequent photodegradation to toxic acids.
³ASTM E 1519-93 definition of paraffinic oil
⁴Modifies ASTM E 896-92, 10 mL oil in open petri dish, exposure is 365 nm UV at 2 mW/cm^{2 for 4 hr.}

It will be understood that these and other types of mineral oils and petrolatums may be used in conjunction with the solution of the present invention to enhance handling characteristics, residue on surfaces, etc.

### Method of Applications:

In one embodiment of the method and formulations of the present invention, use of a capsicum or other capsaicin-containing solution is effective in preventing and eliminating fungal infections in the form of powdery mildew and Downey mildew to vegetation such as grapes. In general, the present invention can be applied on surfaces of the plant, its flowers, seeds, fruits, roots, and the soil in the vicinity of seeds. Delivery can be any known or novel method of delivery of fluid fungicidal compositions to plants or vegetation or other agricultural lands, including but not limited to manually, via mechanical or other fluid sprinkler means, tractor and spray equipment, dusting, air drop or airplane fly-over and delivery from above, etc.

In one embodiment, in the treatment of grapes, the solution is to be administered, without limitation, during the beginning of the season onto fruiting bodies (Cleistothecia) and the early stage of bud growth (approximately 3 to 5 inches). Subsequent treatments include treating new bud growth 3 weeks after the initial treatment. Further treatment is administered to bunches when fruits reach the size of small peas. Also, treatment can be administered anytime when powdery mildew and/or Downey mildew symptoms arise. The use of capsicum for this purpose, in this formulation and method of use, is heretofore unknown, is novel and unique and non-obvious, and provides unexpectedly-high satisfactory results in preventing and removing powdery mildew and Downey mildew.

### Crop Fungus:

Agriculturally, fungus is of primary concern in agricultural areas. The killing solution, comprising an aqueous formulation of capsicum or other capsaicinoid, of the present invention is effective against a range of fungus, including but not limited to the following: Fungi imperfecti, Basidiomycetes, Ascomycetes, and Oomycetes classes which are causes of powdery mildew and Downey mildew.

Thus, the present invention is directed to the use of capsicum or other form of capsaicin for use as a fungicide in agricultural purposes. Such include, but are not limited to, fruit trees and bushes, vegetables, corn, soy beans, grapes, corn, peas, cabbage, lettuce, watermelon, tomatoes, carrots, rhubarb, peppers of all kinds, eggplants, cannola seed, rapeseed, cannabis, apples, cherries, lemons, figs, avocados, grapefruit, oranges, limes, spice plants including herbs, parsley, cilantro, garlic, ginger, onion, potatoes, other seed vegetation, ornamental and edible flowers, organic vegetables, mustard, collard, chard, spinach and other greens, the use of capsicum and water provides a very effective, organic and environmentally-friendly insecticide. The addition of other additives, including mineral oil, surfactants, etc., provides a formulation which is very easy to handle, very effective anti-fungicidal, and is also environmentally non-toxic or damaging. Delivery can be any known or novel method of delivery of fluid fungicidal compositions to plants or vegetation or other agricultural lands, including but not limited to manually, via mechanical or other fluid sprinkler means, tractor and spray equipment, dusting, air drop or airplane fly-over and delivery from above, etc. The use of capsicum for this purpose, in this formulation and method of use, is heretofore unknown, is novel and unique and non-obvious, and provides unexpectedly-high satisfactory results.

### Case Studies

### General Test Protocol First Year:

### Objective

The objective of this study was to test the affect of capsicum on Powdery Mildew (PM), Uncinula Necator and Downey Mildew (DM), Plasmopara Viticola and its destruction of the grape vine, leaves, flag shoots, shoots and bunches. Grape varieties are susceptible to powdery mildew and Downey mildew, Thompson's Seedless grapes was used as a test subject.

### Treatments

Treatment began in the beginning of the season onto fruiting bodies (Cleistothecia) and the early stage of bud growth (3 to 5 inches). Later treatment was applied again, after about 3 weeks when there was new bud growth. When the fruits were about the size of small peas, treatment is once again applied to the bunches. Treatment was also planned to be administered if symptoms of fungal infections arose.

### Present at the Time of Treatment:

### Robert H. Neumann, Adil Jadallah, M.D., Jim Curtiss, Farm Manager

### Capsicum Used

Kalsec brand water soluble; Code #01-050-02-01
MasterTaste brand oil soluble; Code 500087, Lot #059618

### Vines and Methods of Treatment

The grape vineyard to be treated is located at 19521 American Ave., Kerman Calif.,—Thompson Seedless grapes—NW corner. (Block 5B). Vines were sprayed with standard spray equipment (bottles). The spray was applied at approximately one foot away from the plants and vines. The spray was applied at an application rate of about ½ the usual spray application from a standard tractor rig. The budding fruit was sprayed along with the leaves and new budding growth. The spray was administered from the sides only. Standard tractor spray is from the tops and sides.

### Vine Labeling

| Vine No./Color coding | Treatment Solution | Remarks |
|---|---|---|
| 1-4 (Pink label) | Water only | Control |
| 5-8 (Orange label) | 1:50 water soluble ratio | (Capsicum and |
| | | water only) |
| 9-14 (Pink label) | 1:100 water soluble ratio | |
| 15-18 (Orange label) | 1:150 water soluble ratio | |
| 19-25 (Pink label) | 1:100 oil soluble ratio | (Capsicum |
| | | and oil only) |
| 26-30 (Orange label) | 1:150 oil soluble ratio | |
| 31-34 (Pink label) | 1:250 water soluble ratio | |
| 35-38 (Orange label) | 1:400 water soluble ratio | |
| 39-42 (Last vine was | 1:500 water soluble ratio | |
| labeled with several | | |
| pink and orange labels) | | |

### Test Details

### First Spray Test: Apr. 4, 2007

Vine 1-4 5.0 ounces of Water only (per vine)
Vine 5-8 6.0 ounces was applied (per vine)
Vine 9-14 8.0 ounces was applied (per vine)
Vine 15-18 4.0 ounces was applied (per vine)
Vine 19-25 4.5 ounces was applied (per vine)
Vine 26-30 4.5 ounces was applied (per vine)
Vine 31-34 5.0 ounces was applied (per vine)
Vine 35-38 4.0 ounces was applied (per vine)
Vine 39-42 4.0 ounces was applied (per vine)

### Second Spray Test: Apr. 26, 2007

Vine 1-4 5.0 ounces of Water only (per vine)
Vine 5-8 4.0 ounces was applied (per vine)
Vine 9-14 6.0 ounces was applied (per vine)
Vine 15-18 4.0 ounces was applied (per vine)
Vine 19-25 4.0 ounces was applied (per vine)
Vine 26-30 4.0 ounces was applied (per vine)
Vine 31-34 5.0 ounces was applied (per vine)
Vine 35-38 4.0 ounces was applied (per vine)
Vine 39-42 4.0 ounces was applied (per vine)

### Results

There was no evidence of any powdery mildew seen at this time.

### Third Spray Test: May 18, 2007

Vine 1-4 9.0 ounces of Water only (per vine)
Vine 5-8 10.0 ounces was applied (per vine)
Vine 9-14 10.0 ounces was applied (per vine)
Vine 15-18 10.0 ounces was applied (per vine)
Vine 19-25 9.0 ounces was applied (per vine)
Vine 26-30 9.0 ounces was applied (per vine)
Vine 31-34 10.0 ounces was applied (per vine)
Vine 35-38 10.0 ounces was applied (per vine)
Vine 39-42 10.0 ounces was applied (per vine)

### Results

There was no evidence of any powdery mildew seen at this time.

### Fourth Spray Test: Jul. 5, 2007

Control Vines 1-4 showed beginning signs of powdery mildew. To prevent spread of powdery mildew, Control Vines 1-4 were treated with capsicum and water solution ratio 1:50. No spray was applied on other tested vines as it did not appear necessary. All fruits on every test vine 1-42 were tasted for the presence of capsicum. None was noted. No outward evidence of any powdery mildew was seen.

Fifth Spray Test (Final Test before Harvest): Aug. 19, 2007

Control Vines 1-4 showed no evidence of powdery mildew. No spray was applied as it did not appear necessary prior to harvest. All fruit on every test vine was tasted for the presence of capsicum. None was noted. No outward evidence of any powdery mildew was seen.

### Recording Test Data

Test Date: Between Apr. 4, 2007 through Aug. 19, 2007
Time: All sprays and testing was done between 11 a.m. and 3 p.m.
Climate/ Temp: Temp. was between 78-105 degrees Fahrenheit
Stage of crop development
Any anomalies: None
Treatment effectiveness: Appears effective
Does fungus return, and if so how soon after treatment: None
Does it affect the grape or taste: No
Does it work as a pre-infection or a post infection: Appears pre-infection
Record all data you think may be relevant to this study: The growing season only received two-three days of light drizzle/rain only.

### General Test Protocol Second Year:

Test the affect of capsaicin on:
Powdery Mildew (PM), Uncinula Necator
Downey Mildew (DM), Plasmopara Viticola
Grapes—Most varieties are susceptible to PM and DM

This test is a continuation of last years test (General Test Protocol First Year) which demonstrated that capsaicin hinders or kills the growth of mildew on grape vines. General Test Protocol Second Year will determine the affect of capsaicin on grape vineyards and the application issues which may arise on a larger scale. It will also allow us to ascertain the scope of using capsaicin in bulk including spray drift with large industrial equipment, exposure to farm personnel, and mixing and blending large quantities for field use. The grape vineyard to be treated is again located at 19521 American Ave., Kerman Calif.,—Thompson Seedless grapes—NW corner. (Block 5B).

### Present at the Time of Treatment (Initial)

Dr. Adil Jadallah M.D., Robert H. Neumann, Jim Curtiss, Farm Manager, Kenny Hicks, Tractor owner/driver

Not all of the above were present at follow-up visits, however at least two were present at each follow-up visit and 2nd treatment.

### Method of Treatments

The grape vineyard to be treated is located at 19521 American Ave., Kerman Calif.,—Thompson Seedless grapes—NW corner. (Block 5B). The first treatment will spray the vineyard at approx. 40 gallons per acre using standard farm spray equipment. The spray tank used will be approx. 500 gallons. Standard nozzles and spray harnesses will be used. The crop will be sprayed with a mixture of Kapto DM and/or water (control).

### Kapto™ DM

Kapto™ DM formulation is as follows: 2 gallons of Capsaicin: 500,000 scoville heat units, oil soluble, 2 gallons of Technical grade white mineral oil and 1 gallon of Surfactant.

The vineyard will be treated with Kapto™ DM (finished product above) added to water in the ratio of approx. 1:250. Water was added to the concentrate for a total of 500 gallons per tank. Three 500 gallon tank loads were used to treat the block for a total of 1500 gallons used. All treatments are at the owner or farm manager's discretion. The active ingredient used is all natural (food grade) capsaicin (pepper extract). This material is EPA approved for the use in eliminating pests.

### Control

The control was approx one acre (approx. 517 vines) which was treated with ground water only. This control group was located adjacent the treated vineyard and included the first two rows of vines. Control groups were treated with standard spray tanks. Tanks were triple rinsed prior to use to eliminate any residue from previous treatments. The vines were sprayed with approx. 1 gallon of ground water per 13 vines or 10 ounces of spray per vine.

### Size of Treatment Area

Block 5B is approx. 38-40 acres. Each acre has approx. 517 vines per acre which totals approx. 20,680 vines (40 acres). It was calculated to use approx. 1 gallon per 13 vines or 10 ounces of spray per vine.

### Initial Treatment

Date of initial treatment: Apr. 23, 2008
The test area was treated with Kapto™ DM and/or water (control)

### Follow-Up Treatments or Visits

The vineyard was visited and treated again on Jun. 4, 2008 with the same solution used in the initial treatment (Kapto™ DM). The Control group was examined and initial signs of powdery mildew were visible on some vines (13). This control group was treated with Kapto™ DM to prevent any further spread of Downey Mildew into adjacent vines or crops.

As of Jul. 24, 2008, no outward evidence of any powdery mildew or downy mildew was visible on any vines (including control) in this block.

On September 10th the crop was visited during harvest time to examine the fruit. No outward evidence of any fungus was visible and no taste of capsicum was present on the harvested grapes. No fungus of any kind was seen at this time.

### Frequency of Sprays

The frequency of sprays is determined by the weather and dew-point around the crops. The total spray treatments were two. Jim Curtiss, farm manager stated that this is a dry year and due to the lack of moisture in the air, no further treatments or sprays are necessary for this year. He also stated that the number of sprays per season of traditional Sulfur can number between 4-8 depending on the season and moisture.

### Conclusion

The use of Kapto™ DM on the grape vines showed the effect of preventing and killing Mildew on grape vines. The Control group showed no signs of preventing, eliminating or killing Mildew. The frequency of treatment per acre may be lowered with the use of Capsicum as an active ingredient, and may help farm owners save money on treatment material and equipment use. The use of large spray (farm) rigs and equipment posed no issues as it was easy to mix in the field and did not harm equipment or personal. The control of spray drift was minimal and the tractor owner/operator stated that it was the same as any other pesticide sprayed on fields.

One formulation of the present invention is as such (all measurement by volume):
1 part capsicum
1 part white mineral oil
0.5 parts surfactant

Thus, one embodiment of method of the present invention is effective in protecting vegetation from destruction or compromise by fungal infections that cause powdery mildew and Downey mildew. The method consists of contacting the crop with an aqueous formulation containing water, mineral oil and capsicum as the active ingredient. The crop can be contacted with a coating of the capsicum-containing solution. Special protection is afforded to the crop when they are sprayed in the beginning of the season onto their bodies. Treatment continues with another coating after 3 weeks of plant growth. Another coating is applied when or if the crop yields fruit. Treatment should also be administered if symptoms of fungal infection arises.

It will be understood that the present invention is specifically directed to different vegetation as well as with different modalities of destruction by powdery mildew and Downey mildew. The method of the present invention utilizes a composition containing capsicum as the active ingredient, and which may also contain thickeners, adherents, colorants or odorants, other chemicals or compounds, drying agents, and carriers, etc. Furthermore, the method is novel with particular respect to protection of the crop from the time treatment.

Unless defined otherwise, all technical and scientific terms used herein have the same meaning as commonly understood by one of ordinary skill in the art to which this invention belongs. Although any methods and materials similar or equivalent to those described can be used in the practice or testing of the present invention, the preferred methods and materials are now described. All publications and patent documents referenced in this application are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1. An aqueous solution for inhibiting the growth of fungal infection on agricultural crops, the solution formulation containing water, optionally mineral oil, and between about 1 to 50 parts and about 1 to 500 parts by volume capsicum.

2. The solution for inhibiting the growth of fungal infection on agricultural crops of claim 1, wherein the formulation by volume containing one part capsicum, one part white mineral oil and half part of surfactant.

3. A method for inhibiting the growth of fungal infection on agricultural crops, the method comprising the step of applying an aqueous solution formulation containing capsicum directly to the agricultural crop.

4. The method of claim 3, wherein said method inhibits fungal infection causing powdery mildew.

5. The method of claim 3, wherein said method inhibits any type of fungal infection in agricultural crops.

6. The method of claim 3, wherein said method inhibits fungal infection causing Downey mildew.

7. The method of claim 3, wherein said agricultural crops include any one or more of the vegetation in the group consisting fruits, vegetables, grains and legumes.

8. The method of claim 3 further comprising the step of adding an handling additive to the solution, the handling additive selected from the group consisting of mineral or other inert carrier oils, surfactants, dispersants and fragrances.

9. The method of claim 3 in which the step of applying the aqueous solution directly on the agricultural crops is accomplished in the beginning of a growing season.

10. The method of claim 3 in which the step of applying the aqueous solution directly on the agricultural crops is administered if symptoms of fungal infection arise.

11. The method of claim 3 in which the step of applying the aqueous solution directly on the agricultural crops is administered as mildew symptoms arise.

12. A method for eliminating fungal infection on growing grapes, the method comprising the step of applying an aqueous solution formation containing capsicum directly onto the growing grape plants.

13. The method of claim 12 further comprising the step of applying an aqueous solution formation containing capsicum onto fruiting bodies.

14. The method of claim 12 further comprising the step of applying an aqueous solution formation containing capsicum onto growing buds.

15. The method of claim 12 further comprising the step of applying an aqueous solution formation containing capsicum onto fruit at the stage when they are approximately the size of peas.

16. The aqueous solution of claim 1, comprising about 1 to 250 parts by volume capsicum.
